(19) United States
(12) Patent Application Publication
(10) Pub. No.: US 2022/0331944 A1
(43) Pub. Date: Oct. 20, 2022

(54) Convertible Rolling Workbench

(71) Applicant: Gary Moffat, Arlington, WA (US)

(72) Inventor: Gary Moffat, Arlington, WA (US)

(21) Appl. No.: 17/724,236

(22) Filed: Apr. 19, 2022

Related U.S. Application Data
(60) Provisional application No. 63/176,569, filed on Apr. 19, 2021.

(51) Int. Cl. B25H 1/16; B25H 1/04

(52) U.S. Cl. CPC B25H 1/16; B25H 1/04

(57) ABSTRACT

A convertible rolling workbench supports a worker when sitting or kneeling. The workbench includes a bench structure that can be used alone or selectively attached to a dolly. The bench structure includes two vertical leg assemblies. Each leg assembly includes two legs and upper and lower support bars extending between the two legs near their first and second opposite ends. The bench structure is affixed to the two leg assemblies and offset from the workbench's horizontal center axis. The dolly includes two horizontal frame members and an intermediate planar member extending between them. Attached to each horizontal frame member is a caster wheel. Each frame member includes a receiver configured to receive said first or second ends of the vertical legs on said leg assemblies. The user may also rotate the bench seat assembly over the dolly or directly over a support surface to position the seat at different elevations above the support surface. Locks are provided to prevent the dolly from rolling over a support surface. The intermediate planar member may be a wide tray used to hold tools in one embodiment.

This utility patent application is based on and claims the filing date benefit of U.S. Provisional patent application (Application No. 63/176,569) filed on Apr. 19, 2021 and U.S. Provisional patent application (Application No. 63/297,512) filed on Jan. 7, 2022.

Notice is given that the following patent document contains original material subject to copyright protection. The copyright owner has no objection to the facsimile or digital download reproduction of all or part of the patent document but otherwise reserves all copyrights.

### BACKGROUND OF THE INVENTION

### 1. Field of the Invention

This invention relates to workbenches and, more particularly, to workbenches that can be used in different configurations that allow a user to comfortably sit or kneel and work at different elevations and can be selectively attached to a low-profile dolly.

### 2. Description of the Related Art

Employees of a motor vehicle or a marine body or a detailing shop must work for long hours at different areas on the motor vehicle or boat. Often the employees must use small tools, tape, pads, and sandpaper and apply various liquids and pastes to the damaged surface. Sometimes, the damaged surface extends vertically over a large area that requires the worker to stand, sit or kneel in one location for long periods. Sometimes, the damaged surface extends horizontally over a large area, requiring the worker to move horizontally over a support surfacer while sitting or kneeling. When sitting or kneeling for long periods, standing up can be difficult. Often, the area around the damaged surface is a vertical or curved surface that prevents the worker from temporarily resting tools or items needed or the repair.

What is needed is a portable workbench that can be easily configured to allow a worker to sit or kneel when working on a surface. Also needed is a workbench that selectively and securely attaches to a dolly when in a sitting or kneeling configuration that allows it to roll over a flat support surface.

What is also needed is a workbench with horizontal support bars that the user may use to help lower or lift himself on or off the workbench.

What is also needed is a workbench that can hang or store tools and other items within easy reach when sitting or kneeling on the workbench.

### SUMMARY OF THE INVENTION

A convertible workbench disclosed herein solves the problem of comfortably supporting a user in either a sitting or kneeling position when working on an object. The workbench is designed to be used in one of two configurations—a sitting configuration and a kneeling configuration. The workbench is also designed to be selectively and securely attached to a low-profile dolly when in a sitting or kneeling configuration. The workbench also includes support bars that the user may lift or lower himself over the workbench.

The workbench includes a bench structure attached at its opposite ends to two vertical leg assemblies. Each leg assembly includes two vertical legs and two horizontal support bars extending between the two legs. The two horizontal bars in each leg assembly are spaced apart and located near the top and lower ends of the two legs. The bench structure extends between and is offset with the center axis of the two leg assemblies. The bench structure includes a rigid frame sandwiched between two cushions in one embodiment. Because the rigid frame is offset from the leg assemblies' center axis, the distances from the cushions to the opposite ends of the legs are different. This feature allows the user may change the height of the cushions above the support surface at a higher elevation for sitting or at a lower elevation for kneeling by rotating the workbench over the support surface

Each leg assembly includes two support bars that the user may use to lower or lift himself onto the workbench or hang tools or other items within easy reach.

The workbench can be used separately or used with a low-profile dolly with two pairs of caster wheels. The dolly includes two end frames and a lower planar support extending between the two end frames. In one embodiment, the lower planar support is a wide tray configured to hold tools and other items directly under the bench structure's front edge.

Attached to the dolly are two pairs of leg receivers configured to receive the ends of the legs on the two leg assemblies. The four leg receivers are aligned and spaced apart so that all four legs on the bench structure captured. Locks are provided on the leg receivers that securely lock the legs into the leg receivers. An optional carrying handle is attached to the dolly. In one embodiment, at least one caster wheel includes a lock that prevents the dolly from rolling over a flat support surface.

### DESCRIPTION OF THE DRAWINGS

FIG. 1 is a side perspective view of the adjustable rolling workbench.

FIG. 2 is a side devotional view of the bench configured for sitting and attached to the low-profile dolly.

FIG. 3 is a side elevational view of the bench configured for sitting and placed directly on the ground.

FIG. 4 is a side elevational view of the bench configured for kneeling and attached to the low-profile dolly.

FIG. 5 is a side elevational view of a convertible workbench bench configured for kneeling and placed directly on the ground.

FIG. 6 is a side elevational view of the bench.

FIG. 7 is an end elevational view of the bench.

FIG. 8 is a top plan view of the bench.

FIG. 9 is a top plan view of a low-profile dolly.

FIG. 10 is a side elevational view of the low-profile dolly.

FIG. 11 is a perspective view of the lower end of a leg inserted into a locking receiver formed on the lower horizontal frame member.

FIG. 12 is a perspective view of the lower end of a leg inserted into a non-locking receiver formed on the lower horizontal frame member.

FIG. 13 is a perspective view of a tool pouch holder accessory supported over an upper bar.

FIG. 14 is a perspective view of a tool tray accessory supported over an upper bar.

FIG. 15 is a perspective view of a tool holder accessory supported over an upper bar.

FIG. 16 is a side perspective view of a second embodiment of the adjustable rolling workbench wherein the intermediate planar member is a wide tray.

FIG. 17 is a top plan view of the dolly with a wide tray shown in FIG. 16.

### DESCRIPTION OF THE PREFERRED EMBODIMENT(S)

A convertible rolling workbench 10 includes a convertible bench 12 configured to be rotated 180 degrees to acts as a sitting structure or a kneeling structure. The bench 12 includes a bench structure 40 supported at its opposite end by two vertical leg assemblies 14. Each leg assembly 14 includes two legs 16, 22. Extending between the two legs are two bars 30, 32. The bars 30, 32 are located near the opposite first and second ends of the legs 16, 22, respectively.

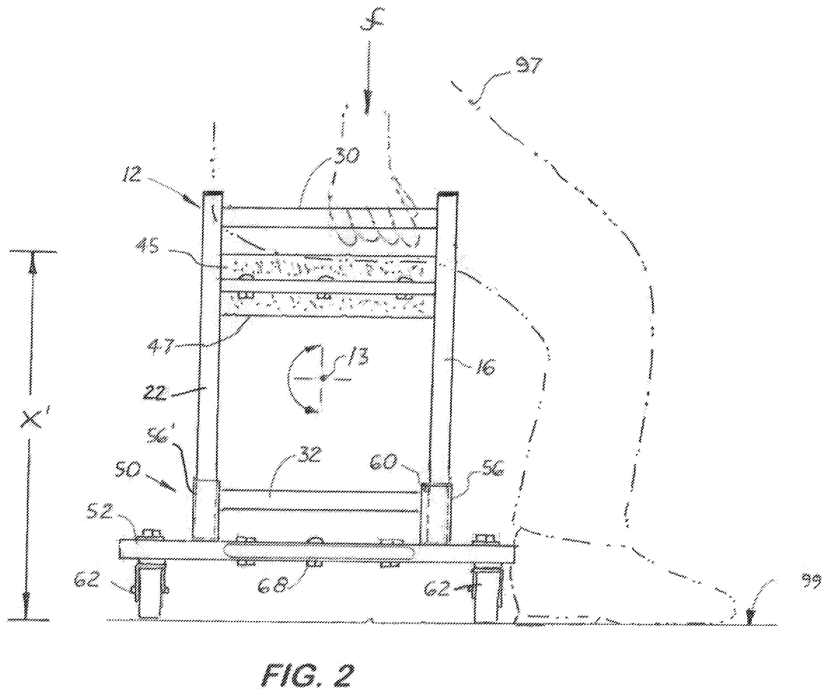

The bench structure 40 includes rigid frame 42 attached at its opposite ends to the two leg assemblies 14. Extending over the top and bottom surfaces of the rigid flame 42 are two optional cushions 43, 45. The rigid frame 42 is aligned offset from the center axis 13 (see FIG. 2) of the leg assemblies 14, 14′ so that when the workbench 10 is rotated 180 degrees around its center axis 13, the first and second ends of the leg assemblies 14 14′ are supported on the support surface 99, reposition the bench structure 40 at different elevations above the support surface 99.

Each leg assembly 14, 14′ includes two horizontal support bars 30, 32 extending between the two legs 16, 22 near their opposite ends. The support bars 30, 32 may be used as push-off bars used help the user lift or lower himself onto the bench 12.

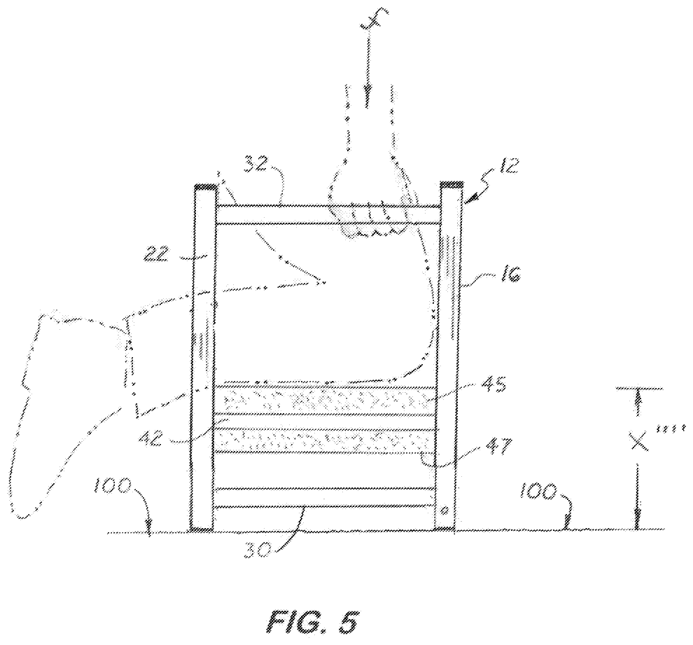

Overall, the workbench 10 is approximately 20 to 24 inches in length, 12 to 14 inches in width. The legs 16, 22 are 12 to 24 inches in height. The support bars 30, 32 are approximately 1 inch in diameter. The center axis of each support bar 30, 32 is approximately 2 inches from the first and second ends of the leg 16, 22. The rigid frame 12 is horizontally aligned and attached to the legs 16, 22 at a location approximately ¼ to ⅓^{rd} of the overall length of the leg 16, 22 as shown in FIGS. 2-7.

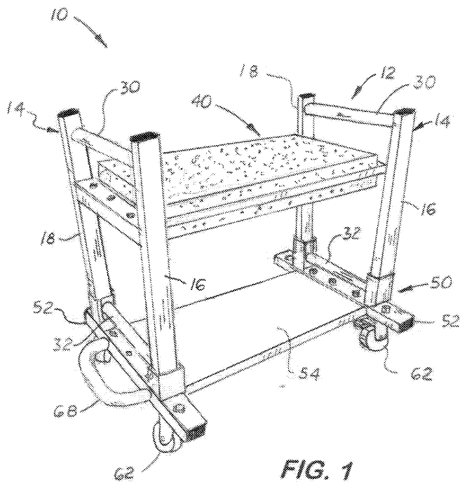

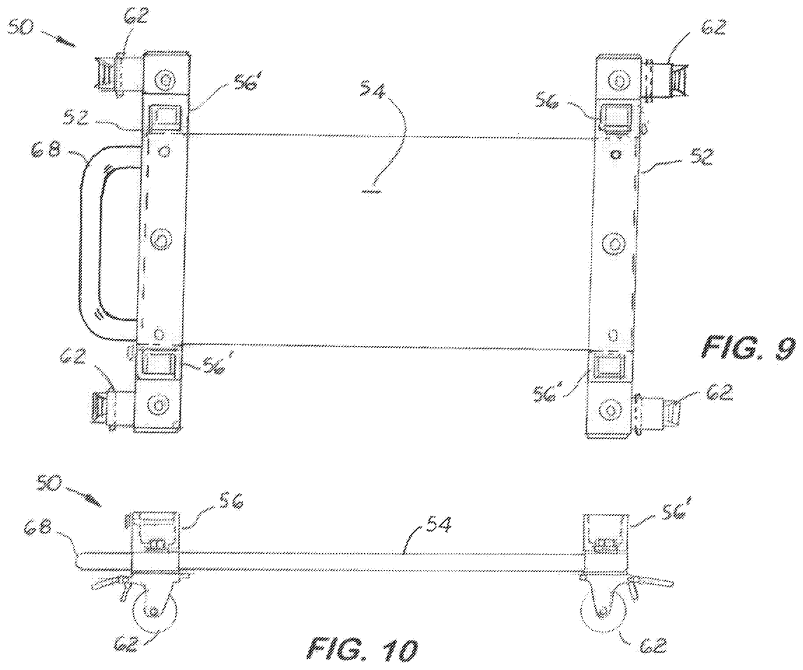

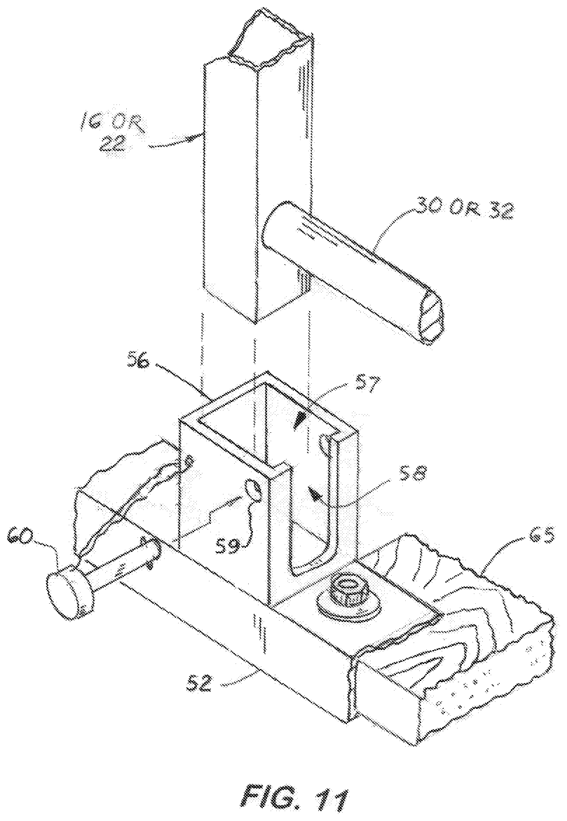

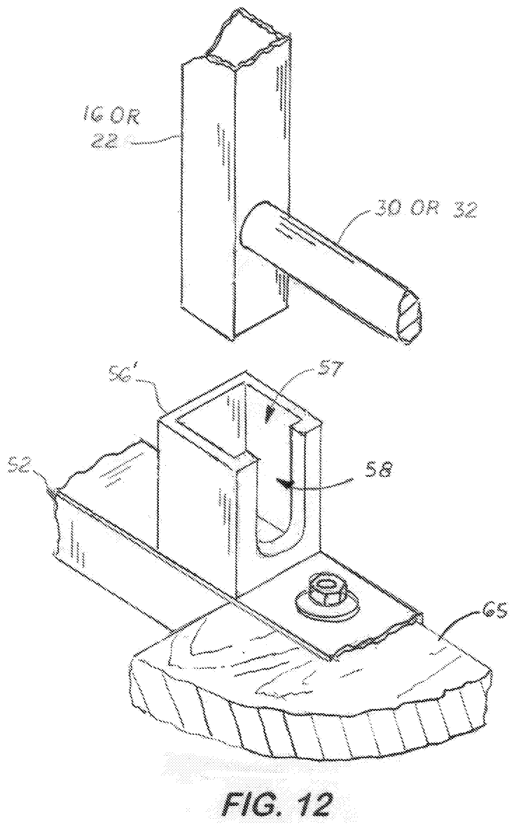

The above-described workbench 10 may be used independently or selectively attached to a low-profile dolly 50. The dolly 50 includes two end frames 52, 52′ and an intermediate planar member 54 extending between the two end frames 52, 52′. In the embodiment shown in FIGS. 1, 9, and 10, the ends of the intermediate planar member 54 extend into slots formed on the two end frames 52, 52′. Threaded connectors connect the end frames 52, 52′ to the opposite ends of the intermediate planar member 54. Extending downward from each end frame 52, 52′ are two caster wheels 62. Incorporated into at least one caster wheel 62 is a lock 63. When assembled, the top surface of the dolly 50 is positioned approximately 2.5 to 3.5 inches above the support surface 99.

Formed or attached to each end frame 52, 52′ are two leg receivers 56 configured to receive the ends of the four legs 16, 22 to securely hold the bench 12 on the dolly 50. At least two leg receivers 56 include pinholes 59 that receive locking pins 60 that pass through the lower end of a leg 16, 22 when inserted into the leg receiver 56 to lock the leg 16, 22 into the leg receiver 56. The leg receivers 56 have the same cross-sectional shape as the leg 16, 22 and include a central cavity 57 configured to receive the end of a leg 16, 22. In addition, each leg receiver 56 includes a vertically aligned slot 58 that allows a support bar 30 or 32 to extend through. The pinhole 59 on the leg receiver 56 is located above the top surface of the leg receiver 56 so that the pin 60, when extended through the pinhole 59, extends over or through the upper or support bars 30, 32, respectively, to hold the leg 16, 22 inside the leg receiver 56.

Attached to the dolly 50 is an optional handle. In the embodiments shown in the Figs, the optional handle 68 is attached to an end frame 52.

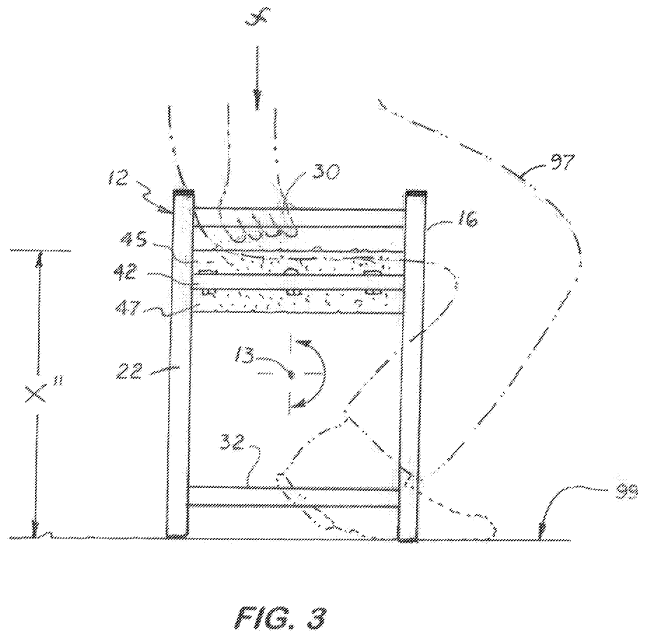

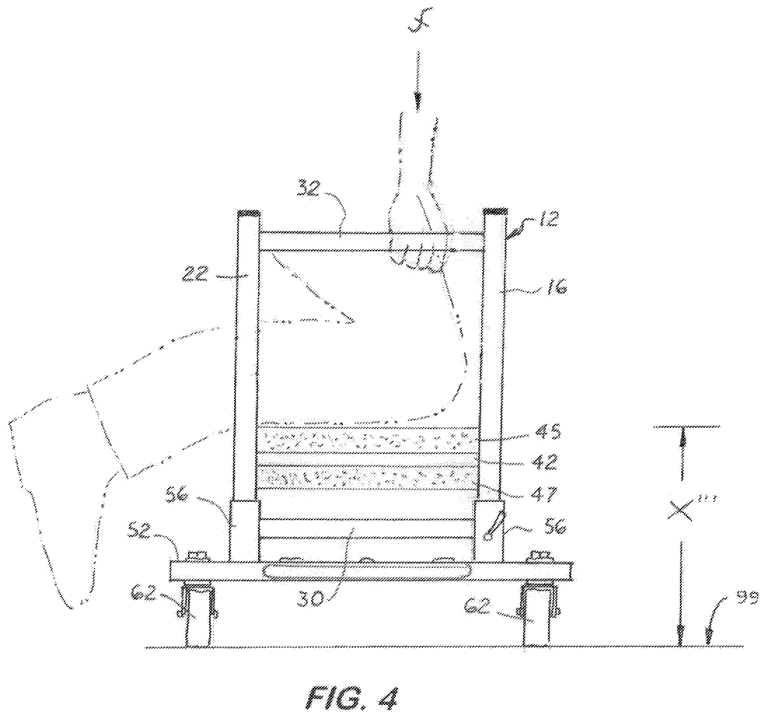

As stated above, bench 12 is designed to be connected to or detached from the dolly 50 during use. In both uses, the bench 12 is configured to be rotated 180 degrees around its horizontal axis 13 so that cushions 45, 47 on the bench structure 40 may be positioned at different elevations above the support surface 99 or above the dolly 50. FIG. 2 shows bench 12 attached to the dolly 50 and rotated for sitting. FIG. 3 shows the bench 12 detached from the dolly 50 and placed directly on the support surface 99 for sitting. FIG. 4 shows the bench 12 mounted on the dolly 50 configured for kneeling. Finally, FIG. 5 shows bench 12 placed on the support surface 99 and used for kneeling.

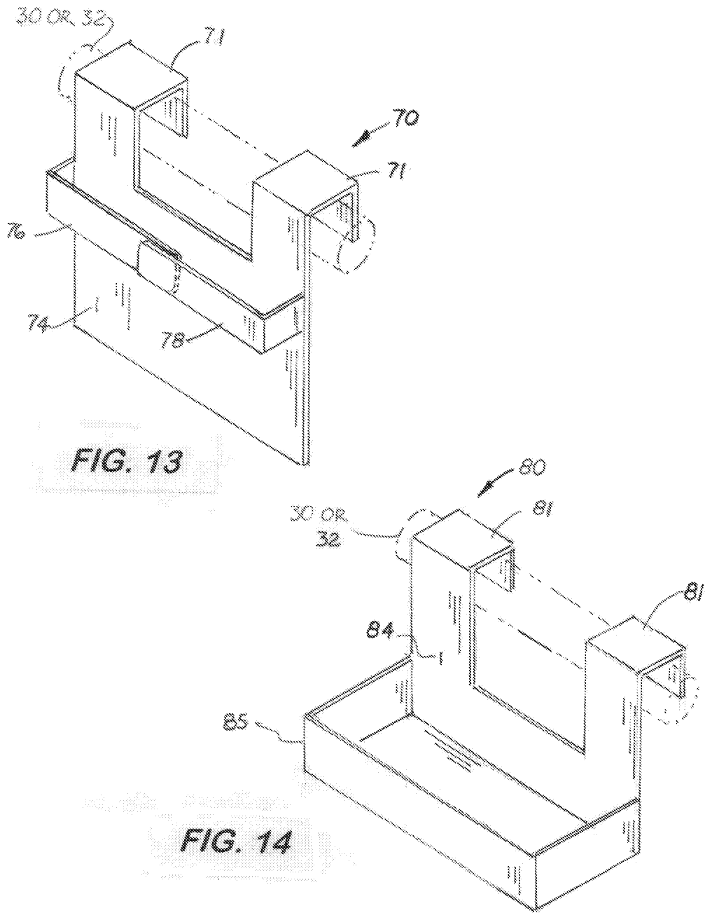

In every configuration, the user may use the support bar 30 or 32 near the upper ends of the legs 16, 22 as a hand grip to lift their body off the bench 12 when sitting or kneeling. In addition to using the upper and lower bars 30, 32 as lifting structures, they may also be used as support structures for various tool holders. For example, FIG. 13 is a perspective view of a tool claiming holder accessory 70 supported over an upper bar 30 or 32. Accessory 70 includes a vertical plate 74 with two upper arms 71 that extend over and selectively capture the upper or lower bar 30, 32. Attached to the plate 74 are two vertical arms 76, 78 with detached ends and overlap to engage a pouch, a pair of gloves, or a similar structure.

FIG. 14 is a perspective view of a tool tray accessory 80 supported over an upper support bar 30 or 32. Tray accessory 80 includes a vertical plate 84 with two upper arms 81 that extend over the bars 30 or 32. The vertical plate 84 is a tray 85 configured to hold small tools and/or screws, bolts, washers, and nuts.

FIG. 15 is a perspective view of a third accessory comprising a hand tool holder accessory 90 used to hold larger hand tools, such as powered screwdrivers, drills or buffering equipment. Accessory 90 includes a vertical plate 94 with two upper arms 91 that extend over and selectively capture the upper or lower bar 30, 32. Attached to the vertical plate 94 is a tool support plate 95. The tool support plate 95 is angled upward at an angle ‘∞,’ of approximately 10 degrees from the horizontal axis. Formed on the tool support plate 95 is an optional cutout 96 that allows the hand tool to rest horizontally on the vertical plate 96 on one end. In every tool holder 70, 80, and 90, two upward arms 74, 84, 94, respectively, over an upper bar 30 or lower bar 32.

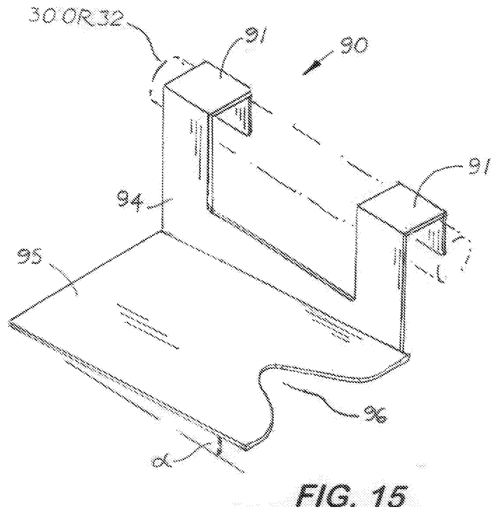

FIGS. 16 and 17 show a second embodiment of the adjustable rolling workbench wherein the intermediate planar member on the dolly 50′ is a wide tool tray 100. The tool tray 100 may replace the lower planar support 54 shown in FIGS. 1, 9 and 10, or it may be attached to the top surface of the lower planar support 54. The tool tray 100 is configured to extend beyond the front edge of the bench structure 40, thereby enabling the user to quickly deposit and remove items from the tool tray 100 while sitting or kneeling on the bench structure. In addition, the tool tray 100 may include optional sidewalls 102 that retain tools and other objects (i.e., screws, nuts, bolts, etc.) on the tray 100 when the dolly 50′ moves over a support surface.

It should be understood the bench structure 40 is sufficiently strong to be used by itself as a step stool when configured in a kneeling or sitting position. It is not recommended that the bench structure be used as a step stool when attached to the dolly 50.

In compliance with the statute, the invention described has been described in language more or less specific as to structural features. It should be understood, however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

1. A convertible rolling workbench, comprising:
a. a bench that includes a bench structure extending between two vertical leg assemblies, each leg assembly includes two legs, a first support bar, a second support bar, said first support bar and said second support bar extend between said vertical legs in each said leg assembly, each said vertical leg includes a first end and a second end, said bench structure includes a rigid frame extending between said leg assemblies, said rigid frame being located offset from said first ends and said second ends of said legs;
b. a dolly that includes two frame members and an intermediate planar member extending between said horizontal frame member, each said frame member includes two leg receivers each configured to receive said first end or said second end of said vertical legs on said leg assemblies thereby enabling said bench to be attached to and extend upward over said dolly; and
c. at least one locking pin configured to selectively lock said first end or said second end of said vertical leg inserted into said leg receiver.

2. The convertible rolling workbench as recited in claim 1, wherein said bench structure further includes a top cushion and a bottom cushion.

3. The convertible rolling workbench as recited in claim 1, wherein said intermediate planar member is wider than said bench structure.

4. The convertible rolling workbench as recited in claim 2, wherein said intermediate planar member is tool support tray that extends beyond said bench structure.

5. The convertible rolling workbench as recited in claim 1, further including a tool holding accessory configured to attached to said first support bar or said second support bar.

6. The convertible rolling workbench as recited in claim 5, wherein said tool holding accessory is a tool clamping holder accessory.

7. The convertible rolling workbench as recited in claim 5, wherein said tool holding accessory a tool tray that includes a vertical plate with two upper arms that extend over one of said support bars, attached to vertical plate is a tray.

8. The convertible rolling workbench as recited in claim 5, wherein said tool holding accessory includes a vertical plate with two upper arms that extend over and selectively capture one of said support bars, attached to said vertical plate is an angled tool support.

9. The convertible rolling workbench as recited in claim 1, wherein said first support bar and said second support bar are round in cross-section.

10. The convertible rolling workbench as recited in claim 1, wherein each said leg receiver includes a slot configured to receive said support bar when said legs on said leg assemblies are inserted into said leg receiver.

11. The convertible roiling workbench as recited in claim 9, wherein each said receiver includes a U-shaped slot formed on said leg receiver, said slot configured to receive said support bar when said legs on said leg assemblies are inserted into said leg receiver.

12. A convertible rolling workbench, comprising:
a. a bench that includes a bench structure extending between two vertical leg assemblies, each leg assembly includes two legs, a first support bar, a second support bar, said first support bar and said second support bar extend between said vertical legs in each said leg assembly, each said vertical leg includes a first end and a second end, said bench structure includes a rigid frame extending between said leg assemblies, said rigid frame being located offset from said first ends and said second ends of said legs, attached to said rigid frame is a top cushion and a lower cushion;
b. a dolly that includes two frame members and an intermediate planar member extending between said horizontal frame member, each said frame member includes two leg receivers each configured to receive said first end or said second end of said vertical legs on said leg assemblies thereby enabling said bench to be attached to and extend upward over said dolly; each said leg receiver includes a slot configured to receive said support bar when
c. at least one locking pin configured to selectively lock said first end or said second end of said vertical leg inserted into said leg receiver.

13. The convertible rolling workbench as recited an claim 12, further including a tool holding accessory configured to selectively attached to said first support bar or said second support bar.

14. The convertible rolling workbench as recited in claim 12, wherein said intermediate planar member is tool support tray that extends beyond said bench structure.
